(19) United States
(12) Patent Application Publication
(10) Pub. No.: US 2017/0334707 A1
(43) Pub. Date: Nov. 23, 2017

(54) HALTER FOR CONTROLLING AN ANIMAL

(71) Applicant: Ralph Donaho, Riviera, TX (US)

(72) Inventor: Ralph Donaho, Riviera, TX (US)

(21) Appl. No.: 15/435,824

(22) Filed: Feb. 17, 2017

Related U.S. Application Data
(63) Continuation-in-part of application No. 29/565,193, filed on May 18, 2016, now abandoned.
(60) Provisional application No. 62/349,233, filed on Jun. 13, 2016.

(51) Int. Cl. B68B 1/02; A01K 15/04

(52) U.S. Cl. CPC B68B 1/02; A01K 15/04

(57) ABSTRACT

A halter for coupling a lead to the head of an animal, including a first stranded metallic cable and a second stranded metallic cable. Both cables may be automotive cables already provided with ferrules to discourage unraveling of cable strands. Loops for interconnecting the two cables are established for example by crimp fittings. Screw lug clamps enable adjustment of the effective dimensions of the halter. The halter is secured from coming apart by attachment of a lead thereto, using a snap hook for example.

### CROSS-REFERENCE TO RELATED APPLICATION

This application claims priority to U.S. Provisional Utility Application Ser. No. 62/349,233, filed Jun. 13, 2016, the contents of which are incorporated herein with this reference. This application is also a Continuation-in-Part Application of U.S. Design Patent Application Ser. No. 29565193, filed May 18, 2016.

### FIELD OF THE DISCLOSURE

The present disclosure relates to a halter for controlling an animal.

### BACKGROUND

Training animals, especially for exposition, such as calves requires that a calf be lead around on a lead. A lead is connected to the calf by a halter, which typically encircles the head of the calf. The halter should not be objectionably uncomfortable to the animal, but should be capable of furthering control over the animal by a human handler.

Typically, traditional halters are comprised of leather, grass, or rope. Regardless of the configuration of traditional halters, halters are designed to allow the handlers to apply a downward pressure to the poll of the head, the neck, and/or the bridge of the nose. These traditional halters only provide this downward pressure which sends only a “stop” message to the animal Traditional halters do not provide efficient directional messages. Also, since the straps of the halters are generally made of flat strips of leather, grass, rope, or woven nylon, the applied downward force is generally a diffuse pressure applied across a fairly broad contact surface area at the poll or the nose. Often such a diffuse applied pressure is insufficient to control a more head-strong animal. As a result, the handler feels he or she must apply more and more pressure, until a maximum amount of pressure is being applied or the handler reverts to a hard jerking motion on the animal's head to control it. However, such extreme pressure or motions rarely delivers an understandable message to the animal The result is often a frustrated animal and trainer.

The nature of the halter influences the response of the calf to handling. A halter that encircles the head with little slack will persuade even obstinate animals of the degree of control imparted by the halter.

While a variety of animal halters have been made and used, it is believed that no one prior to the present inventor has made or used an invention as described herein.

### SUMMARY

The disclosed concepts provide a successful design for strong yet yielding halters for farm animals. The novel halter may be made with two metallic stranded cables having crimped fittings to establish loops and connection points. The length of the cables is adjustable, so that the resultant halter fits differently sized animal physiologies. Screw lug clamps are used to selectively increase and decrease the amount of cable actively utilized in the halter to achieve necessary size adjustments.

It is an object to provide improved elements and arrangements thereof by apparatus for the purposes described which is inexpensive, dependable, and fully effective in accomplishing its intended purposes.

This and other objects will become readily apparent upon further review of the following specification and drawings.

### BRIEF DESCRIPTION OF THE DRAWINGS

Various objects, features, and attendant advantages of the disclosed concepts will become more fully appreciated as the same becomes better understood when considered in conjunction with the accompanying drawings, in which like reference characters designate the same or similar parts throughout the several views, and wherein:

FIG. 1 is a schematic plan view of a halter for coupling a lead to the head of an animal, according to at least one aspect of the disclosure;

FIG. 2 is a schematic front elevational view of the halter of FIG. 1 partially installed over the head of the animal, with the head of the animal and the lead now illustrated;

FIG. 3 is similar to FIG. 2, but shows a completed installation, with the lead attached;

FIG. 4 is a schematic plan view of constituent cables making up the halter of claim 1, redrawn from FIG. 1 to reflect a configuration which the halter would take on once installed as shown in FIG. 2;

FIG. 5 is a perspective detail view of a clamp usable with the halter of FIG. 1, drawn to greater scale; and

FIG. 6 is an end detail view of a different clamp usable with the halter of FIG. 1, drawn to greater scale.

### DETAILED DESCRIPTION

In the following description, numerous specific details are set forth in order to provide an understanding of the present invention. It will be apparent, however, to one skilled in the art that the present invention may be practiced without these specific details. Thus, the specific details set forth are merely exemplary. The specific details may be varied from and still be contemplated to be within the spirit and scope of the present invention.

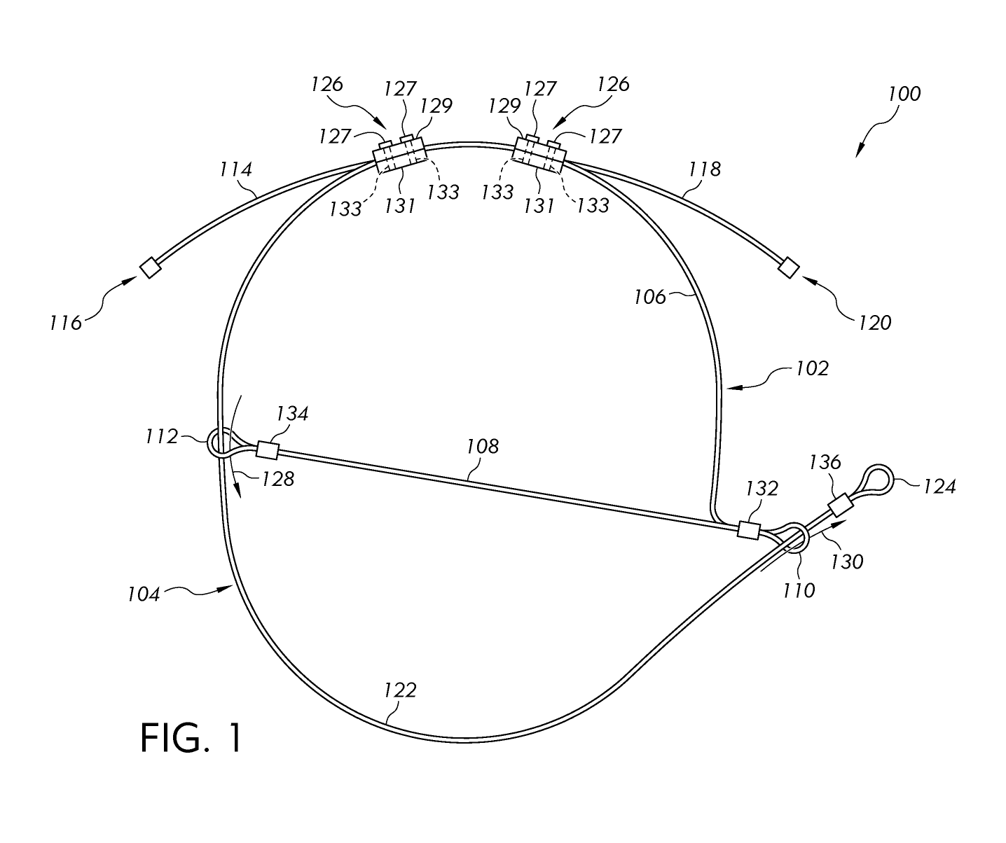

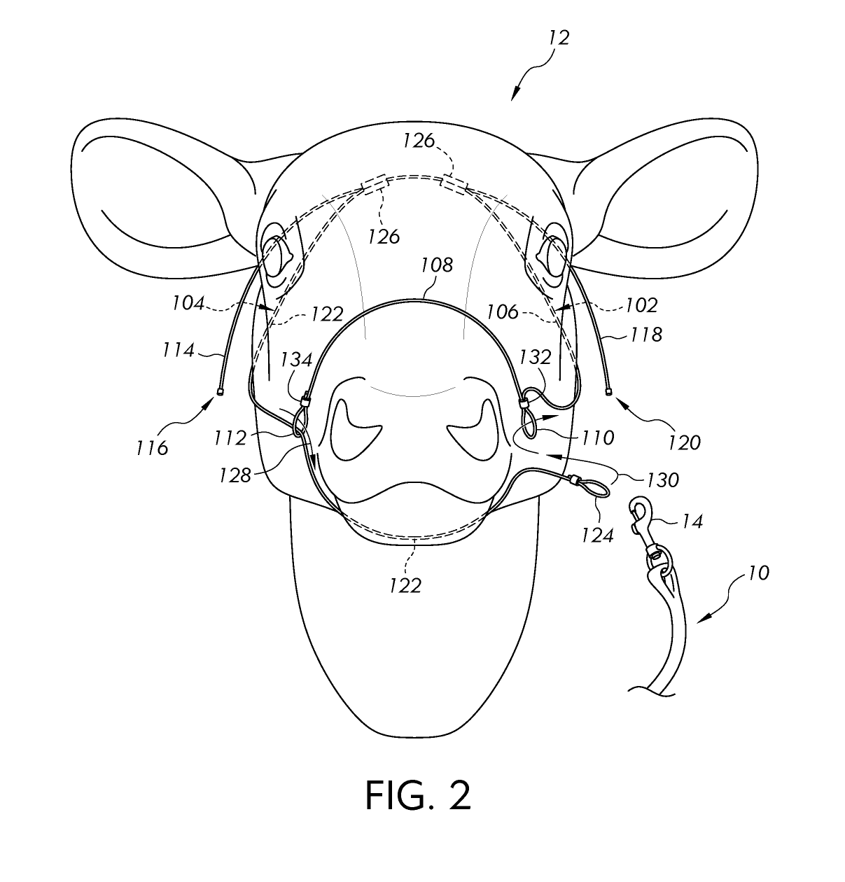

Referring first to FIGS. 1 and 2, according to at least one aspect of the disclosure, there is shown a halter 100 for coupling a lead 10 to the head 12 of an animal (not shown in its entirety). Halter 100 may comprise a first stranded metallic cable 102 including a neck section 106, a nose section 108, an intermediate loop 110 between neck section 106 and nose section 108, a first terminal loop 112 at one end of the nose section 108, the intermediate loop 110 at the other end of nose section 108, and a first free end section 114 terminating at a first free end 116. Halter 100 may also comprise a second stranded metallic cable 104 including at one end, a second free end section 118 terminating at a second free end 120, a chin section 122, and a second terminal loop 124 at an opposed second end of second stranded metallic cable 104, and at least one releasable clamp 126 joining first free end section 114 of first stranded metallic cable 102 to chin section 122 of second stranded metallic cable 104. As will be appreciated from FIG. 2, neck section 106 is that portion of first stranded metallic cable 102 which after installation on the animal extends around the neck and behind the head of the animal. Similarly, nose section 108 is that portion of first stranded metallic cable 102 which after installation on the animal extends over the top of the nose of the animal Chin section 122 is that portion of second stranded metallic cable 104 which after installation on the animal extends beneath the chin of the animal, and will be joined to first stranded metallic cable 102 at intermediate loop 110.

Unless otherwise indicated, the terms “first”, “second”, etc., are used herein merely as labels, and are not intended to impose ordinal, positional, or hierarchical requirements on the times to which these terms refer. Moreover, reference to, e.g., a “second” item does not either require or preclude the existence of, e.g., a “first” or lower-numbered item, and/or, e.g., a “third” +or higher-numbered item.

Referring particularly to FIG. 1, in halter 100, chin section 122 of second stranded metallic cable 104 has been passed though first terminal loop 112 of nose section 108 of first stranded metallic cable 102. Second terminal loop 124 of second stranded metallic cable 104 has been passed through intermediate loop 110 of first stranded metallic cable 102. Although FIG. 1 does not show completion of the passing of chin section 122 through first terminal loop 112, this operation is indicated by an arrow 128. Similarly, passing of second terminal loop 124 through intermediate loop 110 is indicated by arrow 130. Second terminal loop 124 is prevented from spontaneously withdrawing from intermediate loop 110 by connecting snap hook 14 of lead 10 to second terminal loop 124 after the latter has been inserted through intermediate loop 110.

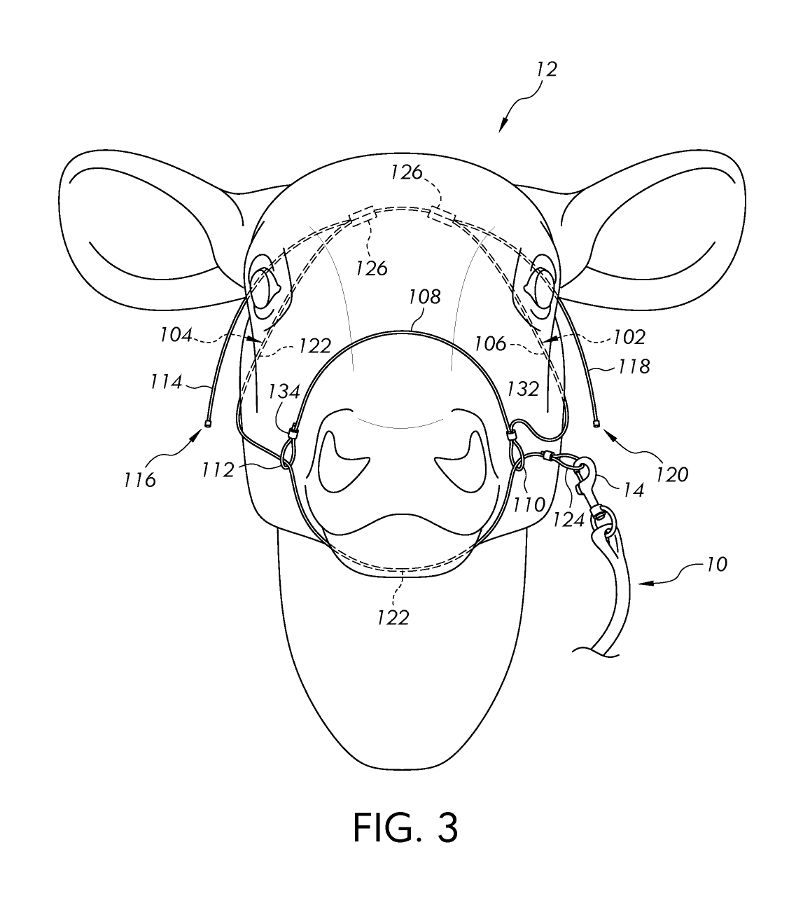

As best appreciated from FIG. 3, first stranded metallic cable 102 may be one of a one eighth of an inch diameter, seven strand, nineteen wire per strand automotive cable or a three thirty-seconds of an inch diameter, seven strand, nineteen wire per strand automotive cable. Second stranded metallic cable 104 may be one of a one eighth of an inch diameter, seven strand, nineteen wire per strand automotive cable and a three thirty-seconds of an inch diameter, seven strand, nineteen wire per strand automotive cable. Automotive cable of three thirty-seconds of an inch diameter will draw more sharply into the skin of an animal than will cable of one eighth of an inch diameter. This can be exploited to bring an unruly animal into compliance when walking or otherwise handling the animal. Tightness of halter 100 is another factor which may be used to control an animal Tightness, as well as fit to the physiology of an individual animal, is controlled by adjusting the lengths of first and second free end sections 114 and 118, and tightening releasable clamps 126 appropriately.

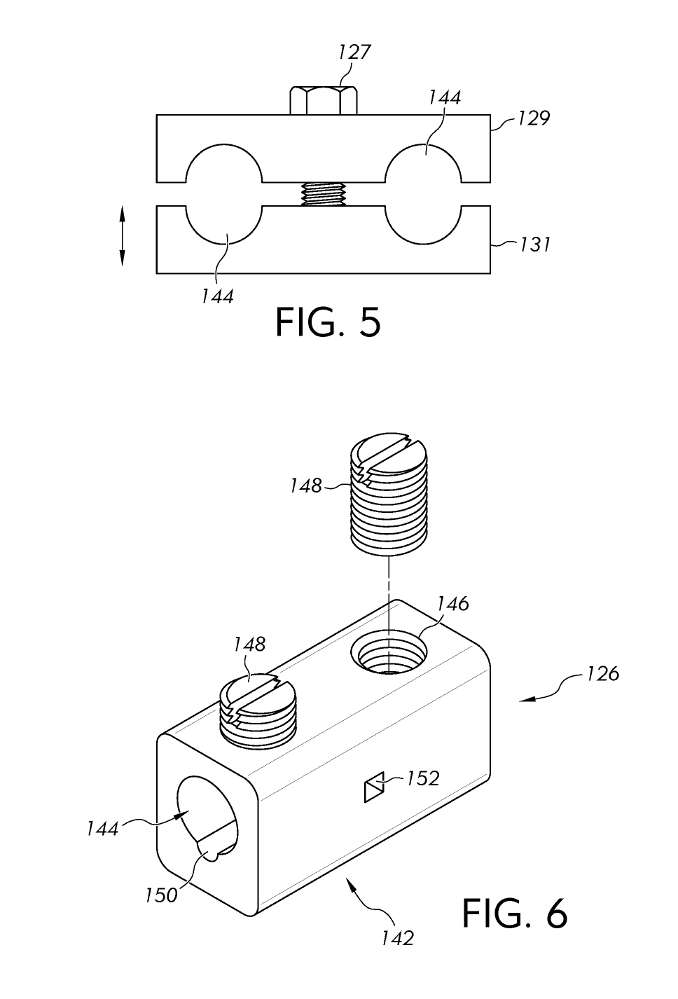

As seen in FIGS. 1, 2, 3, and 5, releasable clamp 126 may be a split or two part screw-vice mechanism whereby one or more screws 127 are passed through a rectangular body 129 that includes one or more smooth bores (not shown) and a base 131. Releasable clamp 126 may comprise body 129, base 131 separable from body 129 and including a threaded hole 133, and screw(s) 127 passing through body 129 and threadably engageable with threaded hole 133 of base 131. Screw(s) 127 is (are) operable to draw base 131 against body 129 when screw(s) 127 is (are) tightened in threaded hole 133. Releasable clamp 126 has at least one throughbore 144 configured and dimensioned to receive first stranded metallic cable 102 and second stranded metallic cable 104 therethrough.

Base 131 includes a threaded bore 133 for each screw 127. Of course, rectangular body may have a smooth walled bore (not shown) for passing through each screw 127. Base 131 is separable from rectangular body 129. The metallic cables 114 and 118 are threaded through the clamp 126 and the screw(s) 127 is (are) tightened, such that the cables 114 and 118 are pinched between the rectangular body 129 and the base 131, thereby preventing cables 114, 118 from moving within the releasable clamp 126. Once adjusted so that first and second free end sections 118 are of desired length, the screw of releasable clamp 126 may be secured in place using a viscous adhesive type substance such as a product of the Loctite brand of Henkel Corp., Westlake, Ohio 44145.

Releasable clamp 126 has been described above as a split or two-piece device. In an alternative shown in FIG. 6, another exemplary releasable clamp 126 may comprise a body 142, a throughbore 144 configured and dimensioned to receive first stranded metallic cable 102 and second stranded metallic cable 104 therethrough, at least one threaded hole 146 in body 142 intersecting throughbore 144, and a threaded setscrew 148 for each threaded hole 146. Threaded setscrew 148 is matingly compatible with an associated threaded hole 146. Only one threaded hole 146 is visible in FIG. 6 as the other threaded hole 146 is occupied by a second threaded setscrew 148. Two setscrews 148 may be provided to more stably pin first and second stranded metallic cables 102, 104 in throughbore 144 in a selected adjustment of a size of neck section 106, nose section 108, and chin section 122 of halter 100. The selected adjustment results in first and second free end sections 114, 118 being of a characteristic exposed length relative to 126. If not stably pinned in place, first and second stranded metallic cables 102, 104 could squirm or otherwise escape secure clamping, and halter 100 could inadvertently lose its adjustment and be unsuitable for use.

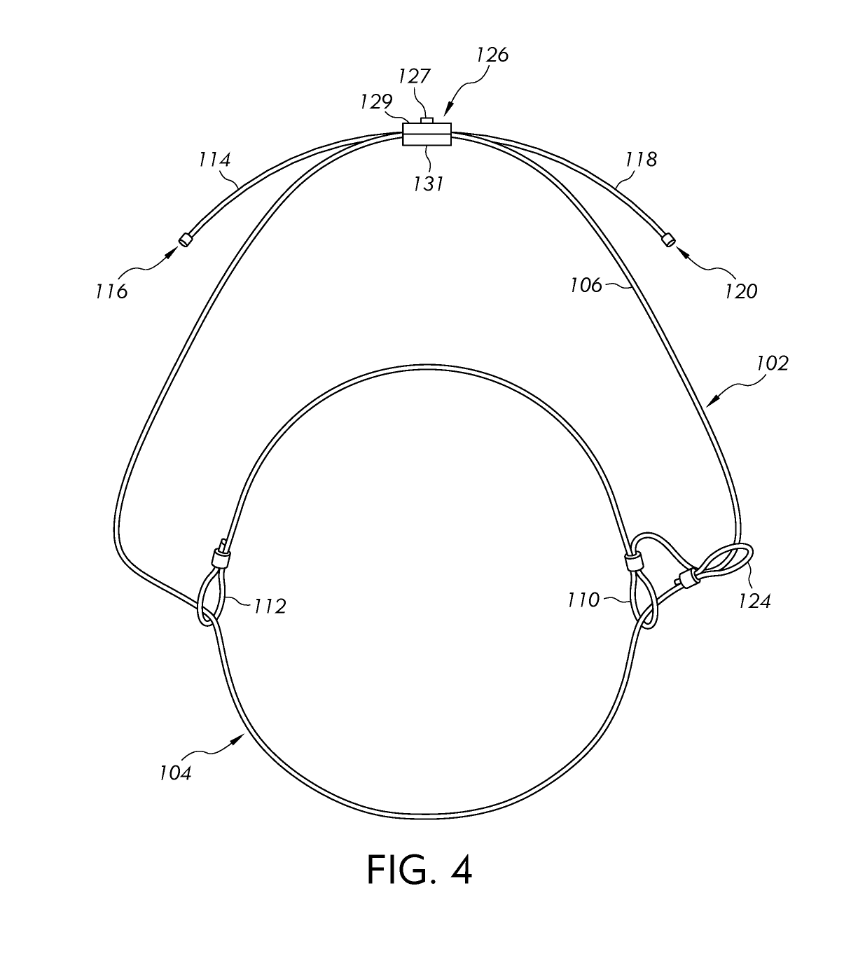

FIG. 4 shows halter 100 in a configuration it would assume when installed on an animal as shown in FIG. 3. In FIG. 4, halter 100 is shown isolated from its associated animal and from lead 10.

Throughbore 144 may have a trough 150 extending therealong, to seat and stabilize first or second stranded metallic cable 102 or 104. Trough 150 may be generally circular as shown, or alternatively, may be wide enough to receive two stranded metallic cables 102, 104 side-by-side in close cooperation with throughbore 144.

Body 142 may include a window 152 extending to throughbore 144.

As shown in FIGS. 1 and 2, releasable clamp 126 is a first releasable clamp, and halter 100 may comprise a second releasable clamp 126 joining first free end section 118 of first stranded metallic cable 102 to chin section 122 of second stranded metallic cable 104.

In one embodiment of halter 100, first stranded metallic cable 102 may further comprise a first crimped fitting 132 securing intermediate loop 110 at a fixed length, and a second crimped fitting 134 securing first terminal loop 112 at a fixed length. Second stranded metallic cable 104 may further comprise a third crimped fitting 136 securing second terminal loop 124 at a fixed length.

Free end 116 of first stranded metallic cable 102 may terminate in a ferrule 138 preventing strands of first stranded metallic cable 102 from unraveling. Free end 120 of second stranded metallic cable 104 may terminate in a ferrule 140 preventing strands of second stranded metallic cable 104 from unraveling. An advantage of using automotive cables to fabricate halter 100 is that they typically include ferrules 138, 140, and will last longer than cables not reinforced by ferrules 138, 140.

It will be seen by examining FIG. 1 that two automotive cables provide most of the basic materials from which halter 100 is fabricated. The only additional materials are first, second, and third crimped fittings 132, 134, 136, and releasable clamps 126.

Novel halter 100, although described in terms of use with calves, may be used with other animals, such as sheep and goats. Halter 100 is intended for walking the animal, such as in display venues, but not for breaking purposes.

While the disclosed concepts have been described in connection with what is considered the most practical and preferred implementation, it is to be understood that the disclosed concepts are not to be limited to the disclosed arrangements, but are intended to cover various arrangements which are included within the spirit and scope of the broadest possible interpretation of the appended claims so as to encompass all modifications and equivalent arrangements which are possible.

It should be understood that the various examples of the apparatus(es) disclosed herein may include any of the components, features, and functionalities of any of the other examples of the apparatus(es) disclosed herein in any feasible combination, and all of such possibilities are intended to be within the spirit and scope of the present disclosure. Many modifications of examples set forth herein will come to mind to one skilled in the art to which the present disclosure pertains having the benefit of the teachings presented in the foregoing descriptions and the associated drawings.

Therefore, it is to be understood that the present disclosure is not to be limited to the specific examples presented and that modifications and other examples are intended to be included within the scope of the appended claims. Moreover, although the foregoing description and the associated drawings describe examples of the present disclosure in the context of certain illustrative combinations of elements and/or functions, it should be appreciated that different combinations of elements and/or functions may be provided by alternative implementations without departing from the scope of the appended claims.

I claim:

1. A halter for coupling a lead to the head of an animal, the halter comprising:
a first stranded metallic cable including a neck section, a nose section, an intermediate loop between the neck section and the nose section, a first terminal loop at one end of the neck section, the intermediate loop at the other end of the neck section, and a first free end section terminating at a first free end;
a second stranded metallic cable including at one end, a second free end section terminating at a second free end, a chin section, and a second terminal loop at an opposed second end of the second stranded metallic cable; and
at least one releasable clamp joining the first free end section of the first stranded metallic cable to the chin section of the second stranded metallic cable.

2. The halter of claim 1, wherein the chin section of the second stranded metallic cable has been passed though the first terminal loop of the nose section of the first stranded metallic cable, and the second terminal loop of the second stranded metallic cable has been passed through the intermediate loop of the first stranded metallic cable.

3. The halter of claim 1, wherein
the first stranded metallic cable is one of a one eighth of an inch diameter, seven strand, nineteen wire per strand automotive cable and a three thirty-seconds of an inch diameter, seven strand, nineteen wire per strand automotive cable, and
the second stranded metallic cable is one of a one eighth of an inch diameter, seven strand, nineteen wire per strand automotive cable and a three thirty-seconds of an inch diameter, seven strand, nineteen wire per strand automotive cable.

4. The halter of claim 1, wherein the releasable clamp comprises a body, a base separable from the body and including a threaded hole, a screw passing through the body and threadably engageable with the threaded hole of the base, wherein the screw is operable to draw the base against the body when the screw is tightened in the threaded hole, and at least one throughbore configured and dimensioned to receive the first stranded metallic cable and the second stranded metallic cable therethrough.

5. The halter of claim 1, wherein the releasable clamp comprises a body, a throughbore configured and dimensioned to receive the first stranded metallic cable and the second stranded metallic cable therethrough, at least one threaded hole in the body intersecting the throughbore, and a threaded setscrew for each said threaded hole, the threaded setscrew matingly compatible with an associated said threaded hole.

6. The halter of claim 1, wherein the releasable clamp is a first releasable clamp, and the halter comprises a second releasable clamp joining the first free end section of the first stranded metallic cable to the chin section of the second stranded metallic cable.

7. The halter of claim 1, wherein the first stranded metallic cable further comprises a first crimped fitting securing the intermediate loop at a fixed length, and a second crimped fitting securing the first terminal loop at a fixed length.

8. The halter of claim 1, wherein the second stranded metallic cable further comprises a third crimped fitting securing the second terminal loop at a fixed length.

9. The halter of claim 1, wherein the free end of the first stranded metallic cable terminates in a ferrule preventing strands of the first stranded metallic cable from unraveling.

10. The halter of claim 1, wherein the free end of the second stranded metallic cable terminates in a ferrule preventing strands of the second stranded metallic cable from unraveling.
